(19) United States
(12) Patent Application Publication
(10) Pub. No.: US 2015/0125289 A1
(43) Pub. Date: May 7, 2015

(54) TURBOMACHINE DISTRIBUTOR AND PRODUCTION METHOD

(71) Applicant: SNECMA, Paris (FR)

(72) Inventors: Sabine Maltaverne, Acheres (FR); Denis Aydin, Paris (FR); Bruno Richard, Chambourcy (FR)

(73) Assignee: SNECMA, Paris (FR)

(21) Appl. No.: 14/401,334

(22) PCT Filed: May 6, 2013
(86) PCT No.: PCT/FR2013/051009

§ 371 Date: Nov. 14, 2014

(30) Foreign Application Priority Data
May 16, 2012 (FR) 1254544

(51) Int. Cl. F01D 25/24; F01D 9/04; F01D 25/28

(52) U.S. Cl. CPC F01D 25/246; F01D 25/28; F01D 9/041; F05D 2230/00; F05D 2230/60
USPC 415/209.2; 29/889.22

(57) ABSTRACT

A part of a turbomachine distributor, including an outer platform, an inner platform, at least one blade interspaced circumferentially about a longitudinal axis of the part, radial ends of the at least one blade being respectively fixed to the inner platform and to the outer platform, and a fastening element extending from the outer platform, for fastening the part to a casing of the turbomachine. The fastening element includes, on ends thereof arranged on either side of the longitudinal axis, two separate fastening tabs for fastening the part to the casing, the cumulated sum of lengths of the two fastening tabs in relation to length of the fastening element according to a transverse axis of the part being between 25% and 35%.

### FIELD OF THE INVENTION

The invention relates to a turbomachine distributor, and a manufacturing method.

### PRESENTATION OF PRIOR ART

A turbomachine includes one or more distributors. This type of part makes it possible in particular to direct the flow of gases at an appropriate angle and speed.

For example, but without limitation, this can be the distributor of a low-pressure turbine, positioned downstream of the high-pressure turbine in the direction of gas stream passing through the turbomachine.

FIG. 1 shows schematically the junction between the high- and low-pressure turbines of a conventional turbomachine.

In this figure, the high-pressure turbine 100 comprises a row of mobile blades 102 distributed circumferentially about a longitudinal axis 104 of the turbine.

As shown by the arrow 106, the gas flow leaving the high-pressure turbine flows toward the distributor 108 of the low-pressure turbine.

The distributor consists in particular of a plurality of fixed blades 110 which extend radially between outer 112 and inner 114 annular platforms constituting supports.

These fixed blades 110, which are also circumferentially distributed about the axis 104, make it possible to direct the gas flow leaving the high-pressure turbine at an appropriate angle and speed.

The inner surfaces 116, 118 of the outer 112 and inner 114 platforms supporting the fixed blades 110 define between them an aerodynamic channel 120 for the flow of the gas stream.

Finally, the distributor includes an upstream attachment element 108 and a downstream attachment element 109, extending from the outer platform, for attaching the part to a casing of the turbomachine. These attachment elements enable, besides attachment to the casing, the prevention of radial leaks of the gas stream out of the stream tube.

One major difficulty in the design of turbomachinery, and of its elements like the distributor, is reduction of overall mass, which must also satisfy all other design requirements, such as limiting leakage from the gas stream.

### Presentation of the Invention

The invention therefore aims to reduce the mass of the distributor, while still limiting leakage of the gas stream from the stream tube.

To this end, the invention proposes a turbomachine part, including:
an outer platform,
an inner platform,
one or more blades, distributed circumferentially about a longitudinal axis of the part, the radial ends whereof are fixed respectively to the inner platform and to the outer platform,
an attachment element, extending from the outer platform, for fastening the part to a casing of the turbomachine,

characterized in that the attachment element includes at its ends, located on either side of the longitudinal axis, two distinct brackets for fastening the part to the casing, the cumulative sum of the lengths of the two brackets compared to the length of the attachment element, along a transverse axis of the part, being comprised between 25% and 35%.

The invention also relates to a turbomachine distributor including a plurality of such parts, the outer and inner platforms whereof are arranged end-to-end and concentrically about a longitudinal axis.

The invention also relates to a manufacturing method for a part as previously described.

The invention makes it possible to reduce the mass of the turbomachine, and to reduce the surplus material to a functional minimum.

The invention also allows a simple and multi-purpose manufacturing method to be obtained.

Finally, the invention allows the mass of the turbomachine to be reduced without a significant increase in the costs of the manufacturing method.

### PRESENTATION OF THE FIGURES

Other features and advantages of the invention will yet appear from the description that follows, which is purely illustrative and not limiting and must be read with reference to the appended drawings wherein:

FIG. 1, already discussed, is a view of a turbomachine distributor of the prior art;

FIG. 2 is a view of one embodiment of a distributor part of a turbomachine according to the invention;

FIG. 3 is a view of another embodiment of a turbomachine distributor part according to the invention;

FIG. 4 is a section view of the attachment of the turbomachine distributor to the casing of the turbomachine;

FIGS. 5 and 6 show pieces of a prior art turbomachine distributor;

FIG. 7 is a schematic view of a casing attachment bracket;

FIG. 8 is similar to FIG. 2;

FIG. 9 is a schematic view of steps in an embodiment of a manufacturing method according to the invention.

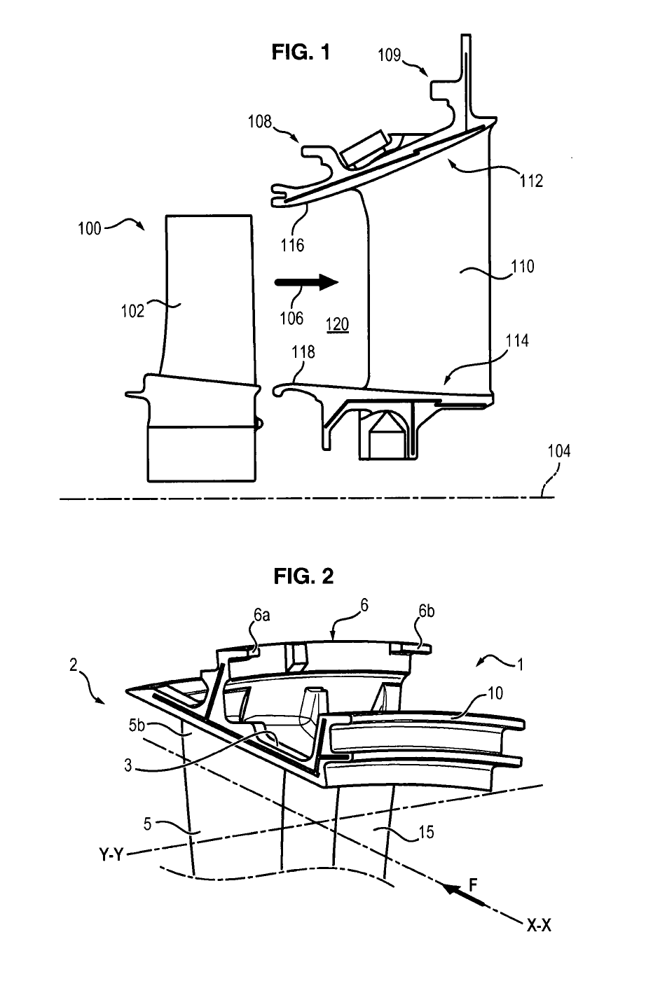

### DETAILED DESCRIPTION

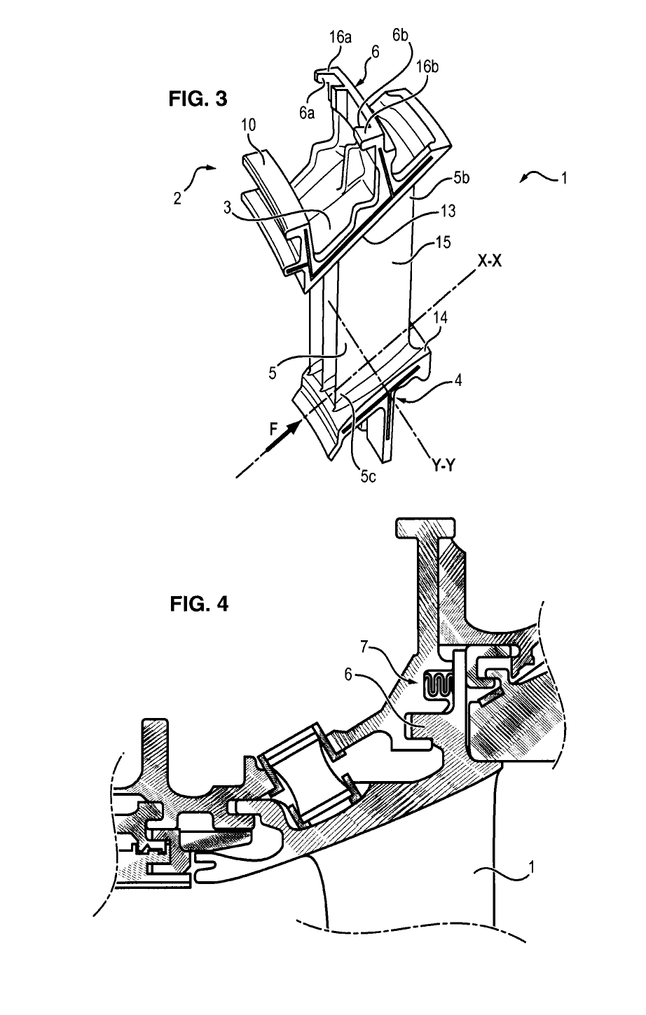

Shown in FIGS. 2 and 3 is an embodiment of a part 2 of a turbomachine distributor 1, according to the invention.

The part 2 comprises a plurality of fixed blades 5 distributed circumferentially about a longitudinal axis X-X of the part.

The upper radial end (or tip) 5b of each blade 5 is fastened to an outer platform 3, which supports it.

Likewise, the lower radial end (or root) 5c of each blade 5 is fastened to an inner platform 4 which supports it.

The inner and outer platforms 3, 4 have an annular segment type of shape.

An outer or inner platform annular segment can serve as a support for a single or for several fixed blades.

In one embodiment, the part 2 includes three blades.

A turbomachine distributor includes a plurality of these parts, of which the outer and inner platforms 3, are arranged end-to-end and concentrically about a longitudinal axis (X-X) of the turbomachine. The distributor makes it possible in particular to direct the gas stream passing through it at an appropriate angle and speed. Such a distributor in particular is used jointly with a turbine or with a flow straightener in a turbomachine.

Alternatively, this can be a single part in the case where the outer and inner platforms each form a complete ring.

The inner surfaces 13, 14 in the outer 3 and inner 4 platforms radially define an aerodynamic channel 15 for the flow of the gas stream passing through the distributor.

The direction of flow of the gas stream upstream of the distributor is shown schematically by the arrow F.

In general, the fixed blades 5 are cooled by introducing air coming from the high-pressure compressor.

The part 2 includes an attachment element 6 extending from the outer platform 3 for attaching the part to a casing 7 of the turbomachine (see FIG. 4).

This attachment element 6 includes, at its ends located on either side of the longitudinal axis (X-X), two distinct brackets 6a, 6b, for attaching the part 2 to the casing 7. These brackets are designed to cooperate with a groove in the casing, for retention by radial contact.

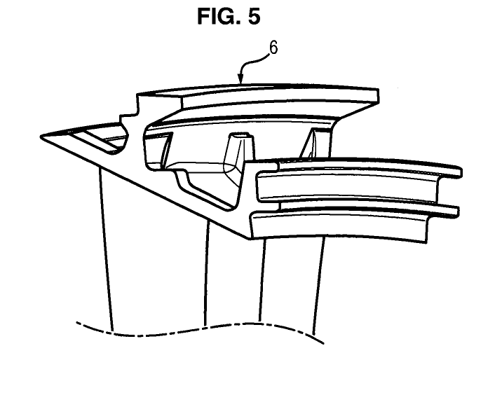

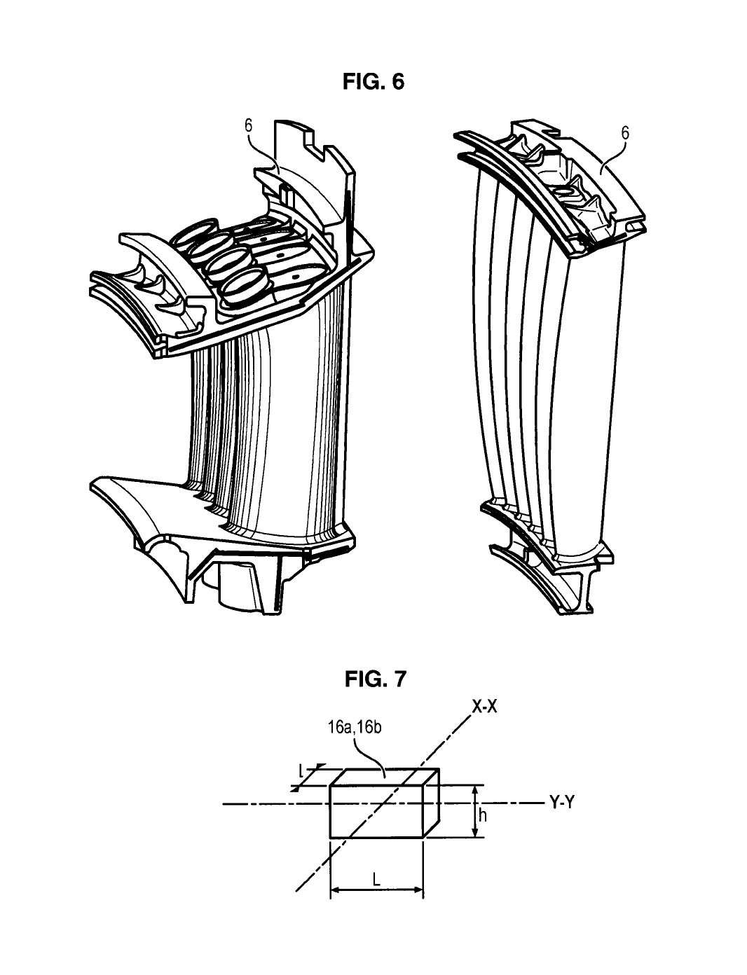

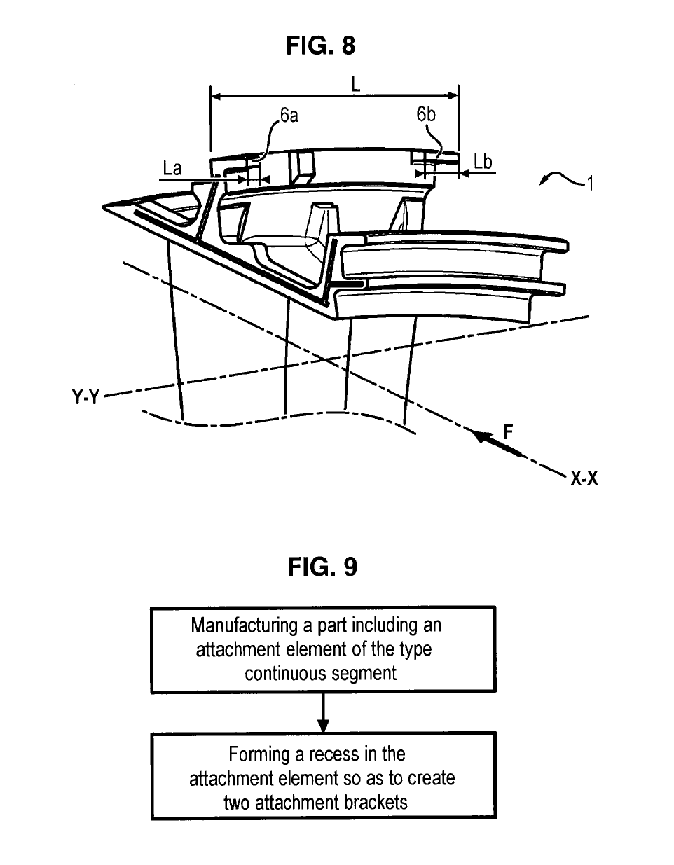

In the prior art (FIGS. 5 and 6), the attachment element 6 consists of a continuous ring segment, extending transversely with respect to the longitudinal axis X-X.

Thus the assembled prior art distributor includes an attachment element 6 having axial symmetry, whatever the number of blades or the angular portion covered by each part of the distributor.

The attachment element 6 provides a radial stop for the distributor, and makes it possible to prevent radial leakage of the gas stream out of the distributor.

Now it has been discovered by the applicant that radial contact between the attachment element 6 and the casing 7 were almost exclusively concentrated at the ends of this element 6, located on either side of the longitudinal axis.

This was highlighted by observation of traces of rubbing between the attachment element 6 and the casing 7 during testing of the turbomachine, but also by 3D modeling.

Consequently, the attachment element 6 was reduced to two distinct attachment brackets 6a, 6b positioned at its transverse ends (Y-Y axis) with respect to the longitudinal axis X-X.

This makes it possible to limit to a strict minimum the material of the attachment element 6 needed for radial contact with the casing 7, while still limiting the induced axial leakage.

This reduction in material allows a noticeable gain in reducing the mass of the turbomachine. In particular, it should be noted that the mass of the attachment element 6 would represent from 2 to 3% of the total mass of the distributor in the prior art. With this modification, the mass of the attachment element 6 no longer represents more than 1% of the mass of the distributor. In terms of absolute value, these are mass gains typically comprised between 350 and 550 g.

The distributor is, for example but without limitation, manufactured of AM1 mono-crystalline superalloy.

The cost of manufacture of the part and of the distributor is only slightly altered by this modification, as only one machining step is for modifying the attachment element 6, as clarified hereafter.

In general, the part 2 includes a second attachment element 10 for attaching the part 2 to the casing 7, the attachment element 6 being positioned downstream of the second attachment element along the longitudinal axis X-X.

The brackets have hexahedron shapes, parallelepipeds for example, but without limitation.

It is possible to optimize the configuration of each bracket 6a, 6b. In particular, in one embodiment, the two brackets have outer surfaces 16a, 16b of width l (along axis X-X) and/or of mutually differing width L. These outer surfaces are outer surfaces in radial contact with the casing. L and l are curvilinear distances.

The dimensions of the outer surface of each bracket can in particular be optimized as a function of parameters such as pressure, temperature, and the Young's modulus of the material constituting these brackets.

The dimensions of the outer surface of each bracket 6a, 6b of a part to be dimensioned can for example be calculated according to the following formulas, relative to a reference part from the prior art.

$$\frac{Δ {L}_{a}}{{L}_{a}} = \frac{Δ L}{L} + \frac{Δ E}{E} + \frac{Δ P}{P}$$

$$\frac{Δ {L}_{b}}{{L}_{b}} = \frac{Δ L}{L} + \frac{Δ E}{E} - \frac{Δ P}{P}$$

The elements of these equations are defined as follows:
L: length of the part to be dimensioned along the transverse axis;
ΔL: this is the difference between the length of the prior art reference part and the length of the part to be dimensioned;
Lₐ (respectively L_{b}): length of the outer surface of the bracket 6a of the part to be dimensioned (respectively bracket 6b);
ΔLₐ (respectively ΔL_{b}): this is the difference between
   the length of the contact area observed on the prior art reference part (that is the length of the observed rubbing zone) at the end of its attachment element positioned on the same side as the bracket 6a (respectively 6b), and
   the length Lₐ (respectively L_{b}) of the bracket 6a (respectively 6b) of the part to be dimensioned;
ΔE: difference between the Young's modulus of the prior art reference part and the Young's modulus of the part to be dimensioned;
ΔP: difference between the pressure in the prior art reference part and the pressure in the part to be dimensioned.

The height h of the brackets along the radial axis generally remains unchanged with regard to the initial height of the attachment element of the reference part (continuous ring segment, see FIGS. 5 and 6). Consequently, axial leakage is not impacted.

As was mentioned, it was discovered by the applicant that radial contacts between the downstream attachment element 6 and the casing 7 were concentrated nearly exclusively at the ends of this element 6, located on either side of the longitudinal axis, that is at the two attachment brackets 6a and 6b.

Modeling and simulations have made it possible to determine that the cumulative sum of the lengths La, Lb of the two brackets 6a, 6b relative to the length L of the downstream attachment element 6 along the transverse axis Y-Y could be reduced by a value comprised between 25% and 35%.

It is noted that the length La and the length Lb can be different.

According to one exemplary embodiment, the length L is substantially equal to 76 mm, the length La substantially equal to 8.5 mm and the length Lb substantially equal to 14.5 mm, for a ratio ([La+Lb]/L) of about 30%.

Thus, the length of the brackets 6a, 6b is notably reduced compared to the length of the attachment element, which makes it possible to reduce the mass of the attachment element while at the same time reducing induced axial leakage and maintaining adequate attachment.

In one embodiment, at least one bracket 6a, 6b has an outer surface with a variable width l. For example, the width l of each bracket can change along an axis Y-Y transverse to the longitudinal axis X-X.

The variability of the width of the bracket can result in particular from iterations between the constraints required for good mechanical strength of the attachment brackets and machining constraints.

By assembling several parts 2 like those which have just been described, a turbomachine distributor 1 is obtained wherein the outer and inner platforms 3, 4 are arranged end-to-end and concentrically about the longitudinal axis X-X. Alternatively, the distributor includes a single part 2, including an outer platform and an inner platform each formed as a single annular part.

In one embodiment, the distributor is a distributor of a low-pressure turbine of the turbomachine.

A manufacturing method for a part 2 of a turbomachine distributor 1 is now described (see FIG. 8).

The method includes a step consisting of fabricating an initial part including:
an outer platform 3,
an inner platform 4,
one or more blades 5, distributed circumferentially about a longitudinal axis X-X of the part 2, the radial ends whereof are fastened respectively to the inner platform 3 and to the outer platform 4,
an attachment element 6, extending from the outer platform 3 and defining a continuous ring segment for attaching the part to a casing of the turbomachine.

This manufacturing step and this part are known from the prior art, and these are for example parts of the type of those illustrated in FIGS. 5 and 6. Starting with this initial part, the method includes the step consisting of forming a recess in the attachment element 6, so as to create, at the ends of the attachment element 6 located on either side of the longitudinal axis X-X, two distinct attachment brackets 6a, 6b for fastening the part 2 to the casing 7.

As previously mentioned, it is advantageous to create two attachment brackets 6a, 6b, the cumulative sum of the lengths La, Lb whereof, compared to the length L of the downstream attachment element 6 along the transverse axis Y-Y, is comprised between 25% and 35%.

It is possible to make, starting from one and the same initial part, different types of recess in the initial attachment element. In particular, the dimensions of the outer surface of each bracket and the shape of each bracket can be defined according to need.

This cutout depends in particular on the machining means selected.

This manufacturing method is optimized and multi-purpose, without involving a significant increase in the cost of manufacture.

Generally, the invention makes it possible to reduce the mass of the turbomachine, and to reduce the surplus material to the functional minimum, while still limiting gas stream losses.

1-8. (canceled)

9. A part of a distributor of a turbomachine, comprising:
an outer platform;
an inner platform;
one or more blades distributed circumferentially about a longitudinal axis of the part, radial ends whereof are fastened respectively to the inner platform and to the outer platform;
a first attachment element, extending from the outer platform, for fastening the part to a casing of the turbomachine,
wherein the first attachment element includes, at its ends located on either side of the longitudinal axis, two distinct attachment brackets for fastening the part to the casing, the cumulative sum of lengths of the two attachment brackets compared with length of the first attachment element along a transverse axis of the part being between 25% and 35%.

10. The part according to claim 9, further comprising a second attachment element for attaching the part to the casing, the first attachment element being positioned downstream of the second attachment element along the longitudinal axis.

11. The part according to claim 9, wherein the two attachment brackets have outer surfaces with mutually differing widths and/or lengths.

12. The part according to claim 9, wherein at least one attachment bracket has an outer surface with a variable width.

13. The part according to claim 9, comprising three blades.

14. A turbomachine distributor, comprising a plurality of parts according to claim 9, the outer and inner platforms whereof are arranged end-to-end and concentrically about a longitudinal axis.

15. The distributor according to claim 14, configured to be the distributor of a low-pressure turbine of the turbomachine.

16. A manufacturing method for a part of a turbomachine distributor, comprising:
manufacturing a part including:
an outer platform;
an inner platform;
one or more blades distributed circumferentially about a longitudinal axis of the part, radial ends whereof are fastened respectively to the inner platform and to the outer platform;
an attachment element, extending from the outer platform and defining a continuous ring segment, for fastening the part to a casing of the turbomachine;
forming a recess in the attachment element to create, at the ends of the attachment element located on either side of the longitudinal axis, two distinct attachment brackets, for fastening the part to the casing, the cumulative sum of lengths of the two attachment brackets compared with length of the attachment element along a transverse axis of the part being between 25% and 35%.
